(19) United States
(12) Patent Application Publication
(10) Pub. No.: US 2004/0252711 A1
(43) Pub. Date: Dec. 16, 2004

(54) Protocol data unit queues

(76) Inventors: David Romano, Cumberland, RI (US); Gilbert Wolrich, Framingham, MA (US); Donald F. Hooper, Shrewsbur, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/460,289

(22) Filed: Jun. 11, 2003

(51) Int. Cl. H04L 12/56

(52) U.S. Cl. 370/412

(57) ABSTRACT

In general, in one aspect, the disclosure describes a method of enqueuing and dequeuing queue entries for protocol data units. The method includes assigning a queue from a set of queues to a received protocol data unit, determining a queue from the set of queues to dequeue based on a scheduling policy, and adjusting a count of entries of the queue to dequeue and the queue assigned to the protocol data unit. After the adjusting, the method includes enqueuing an entry for the received protocol data unit in the assigned queue and dequeueing an entry in the queue to dequeue.

### BACKGROUND

Networks enable computers and other devices to communicate. For example, networks can carry data representing video, audio, e-mail, and so forth. Typically, data sent across a network is divided into smaller messages known as Protocol Data Units (PDUs). By analogy, a PDU is much like an envelope you drop in a mailbox. A PDU typically includes “payload” and a “header”. The PDUs “payload” is analogous to the letter inside the envelope. The PDUs “header” is much like the information written on the envelope itself. The header can include information to help network devices handle the PDU appropriately. For example, the header can include an address that identifies the PDUs destination.

A given PDU may “hop” across many different intermediate network devices (e.g., “routers”, “bridges” and “switches”) before reaching its destination. Generally, an intermediate device features a number of connections to other devices. After receiving a PDU over one connection (the ingress interface), the intermediate device can forward the PDU out another (the egress interface). The manner of determining an egress interface depends on the networking protocol(s) used. For example, a router running the Internet Protocol selects a connection that leads the PDU further down a path toward the destination identified in the PDUs header.

### BRIEF DESCRIPTION OF THE DRAWINGS

FIG. 1 is a diagram of a system to queue and dequeue entries for protocol data units.

FIGS. 2A-2C are diagrams illustrating operation of the system to queue and dequeue entries for protocol data units.

FIG. 3 is a flow-chart of a process to queue and dequeue entries for protocol data units.

FIG. 4 is a diagram of a network processor.

FIG. 5 is a diagram of a network device including a set of line cards interconnected by a switch fabric.

### DETAILED DESCRIPTION

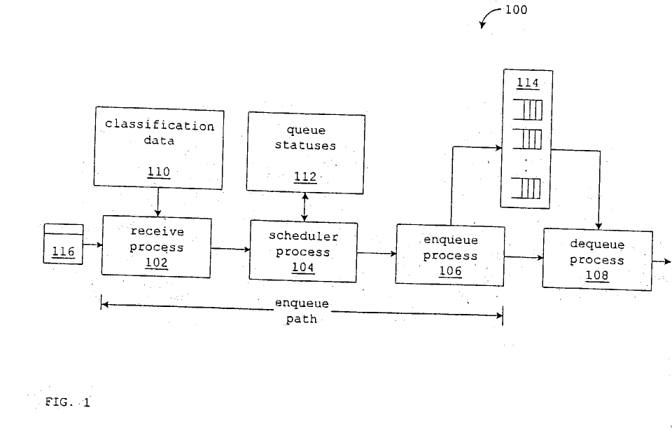

FIG. 1 depicts a system 100 that queues 114 received protocol data units (PDUs). As shown, an enqueue process 106 adds entries for the PDUs to different queues 114. A PDU may be assigned to a particular queue based on a variety of criteria such as PDU destination, a Quality of Service (QoS) associated with the PDU, and so forth. A dequeue process 108 removes entries from the queues 114. After being dequeued, the PDU may be handled in a variety of ways (e.g., transmitted over a switch fabric, dropped, modified, and so forth).

Removal of entries from the queues 114 by the dequeue process 108 is controlled by a scheduler process 104. The scheduler process 104 can implement a variety of scheduling policies (e.g., Deficit Round-Robin (DRR), Weighted-Fair Queuing (WFQ), and so forth) for servicing the queues 114. To implement these policies, the scheduler process 104 can access queue status data 112 such as data identifying a count of queue entries, queue state (e.g., active or empty), queue priority, queue enablement, and so forth.

As shown, the scheduler process 108 forms part of an enqueue path for a received PDU that ends with the queuing of an entry for the PDU. Situated in the enqueue path, the scheduler process 108 can “snoop” data en route to the enqueue process 106 that identifies the queues assigned to received PDUs. Based on this data, the scheduler process 108 can increment queue counts 112 accordingly. The scheduler process 104 can also decrement queue counts 112 based on the queue(s) selected for subsequent dequeuing. Thus, in some implementations, a single process 104 may have complete control over the queue status data 112 instead of being shared, for example by an enqueue process to increment a count, a dequeue process to decrement a count, and a scheduler process to analyze the queue status data 112. This approach can simplify design, reduce access conflicts, and help ensure the consistency of the data 112.

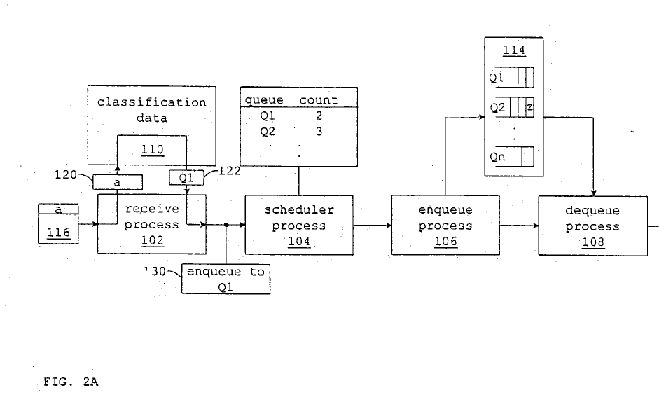

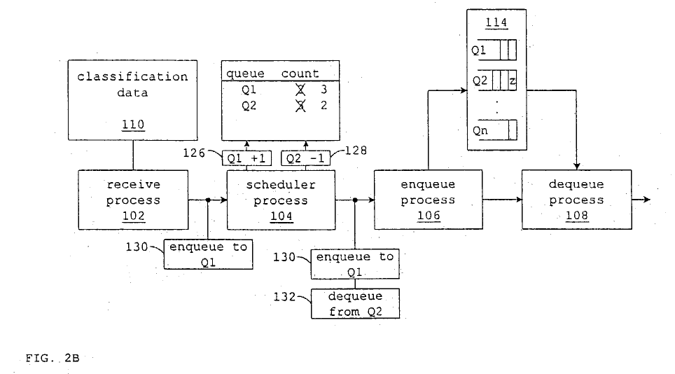

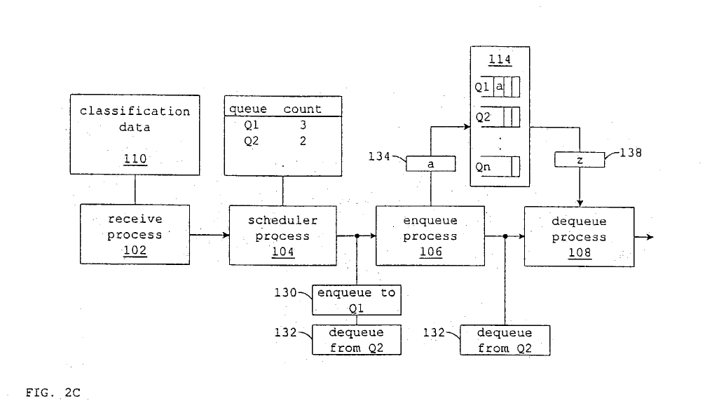

FIGS. 2A-2C depict operation of a sample implementation in greater detail. As shown, the system 100 operates on received PDUs (e.g., PDU 116). The scheme can be used to process a wide variety of PDUs at different layers in a protocol stack such as Internet Protocol (IP) datagrams, Asynchronous Transfer Mode (ATM) cells, link layer frames (e.g., Synchronous Optical Network (SONET), Ethernet, and/or High-Level Data Link Control (HDLC) frames), Transmission Control Protocol (TCP) segments, User Datagram Protocol (UDP) datagrams, and so forth.

As shown in FIG. 2A, the receive process 102 determines a queue for the PDU 116. For example, the process 102 may select a queue based on header contents such as a TCP/IP or UDP/IP flow (e.g., a combination of Internet Protocol source and destination, the source and destination port of an encapsulated transport layer PDU, and a protocol identifier), ATM circuit, a security parameter (e.g., IPSec data), and/or by an MPLS (Multiprotocol Label Switching) label. Queue selection may also be performed based on payload contents (e.g., a Universal Resource Indicator (URI) within a HyperText Transfer Protocol (HTTP) message), by metering characteristics (e.g., committed data transmission rate and maximum burst size), by a QoS specified by Service Level Agreements (SLAs), by traffic shaping policies, and so forth.

As shown, this PDU classification may be table 110 based. For example, in FIG. 2A, the receive process 104 uses data from the PDUs header(s) as a key 120 into a table 110 associating different keys with different queues. For instance, the key may be a TCP/IP flow ID 120 that the table associates with a particular queue 122 (e.g., “Q1”).

The receive process 104 may perform other operations. For example, the receive process 102 may operate on a PDU popped from a receive queue (not shown) and store the PDU in memory using Direct Memory Access (DMA). Additionally, since the PDU may be segmented into smaller cells (e.g., CSIX cells) before being transmitted over a switch fabric, the receive process 104 may determine how many cells will be needed to ferry the PDU across the fabric.

As shown, the receive process 102 can send a message 124 including the determined queue to the scheduler process 104. In the example shown, the receive process 102 notifies the scheduler process 104 that PDU 116 should be enqueued to queue “Q1”. The message 124 may include other data (e.g., the switch fabric cell count, a pointer to the stored packet, and so forth).

As shown in FIG. 2B, based on the message 124 from the receive process 102, the scheduler process 104 can adjust the count of queue entries. That is, as shown, the scheduler can increment the count of PDU entries in queue “1” (e.g., from “2” to “3”) to reflect the upcoming addition of an entry in queue “1” for PDU 116. In this illustration, the count represents a number of queued PDUs. In other implementations, however, the count may represent other queue occupancy metrics (e.g., number of switch fabric cells, bytes, and so forth).

As shown, based on the scheduling policy implemented, the scheduler process 104 selects a queue to dequeue. In this example, the scheduler process 104 selects queue “Q2” for dequeuing. Thus, although the scheduled dequeuing will not occur until the dequeue process 108 is notified, the scheduler process 104 decrements 128 the count of queue “Q2” (e.g., from “3” to “2”).

As shown, the scheduler process 104 can send a message 132 identifying the queue(s) selected for dequeuing in addition to forwarding the message 130 identifying the received PDU's 116 assigned queue. As shown, in FIG. 2C, based on the message 130 identifying the queue assigned to PDU 116, the enqueue process 106 enqueues 134 an entry (e.g., a PDU descriptor, PDU pointer, and/or a copy of the PDU) for the PDU 116 in the assigned queue (“Q1”). Such a queue may be implemented in a variety of ways. For example, the queue may be a linked list of discontiguous memory buffers. In such a queue, the enqueue process 106 may allocate and link buffers for the entry in the queue list.

As shown, the enqueue process 106 passes on identification 136 of the queue(s) to dequeue to the dequeue process 108. In response, the dequeue process 108 dequeues 132 the identified queue (e.g., dequeues PDU “z” from queue “Q2”). Typically, dequeuing implements a FIFO (First-In-First-Out) algorithm. That is, a dequeue operation removes the oldest entry from a queue. Again, operations performed for a PDU after dequeuing may vary in different implementations.

The scheduler process 104 may communicate other information to the enqueue 106 and dequeue 108 processes. For example, in the case where a PDU assigned to a previously empty queue is also selected for dequeuing, the queuing and dequeuing of an entry for the PDU may be bypassed. For instance, the scheduler process 104 may output a message of “Output PDU”.

While FIGS. 2B and 2C depict a pair of messages 130, 132, this data may be packaged in a single message. Additionally, other interprocess communication techniques may be used other than the messaging scheme illustrated.

FIGS. 1 and 2 depicted an implementation that featured a collection of processes 102,104,106,108. Such processes 102,104, 106, 108 may be implemented by a collection of threads having independent flows of control. For example, one or more threads may implement receive process 102, a different thread may implement the scheduler process 104, and so forth. While FIGS. 1 and 2 illustrated processes 102,104,106, 108 as forming a pipeline, the techniques described above may be used in non-pipeline architectures.

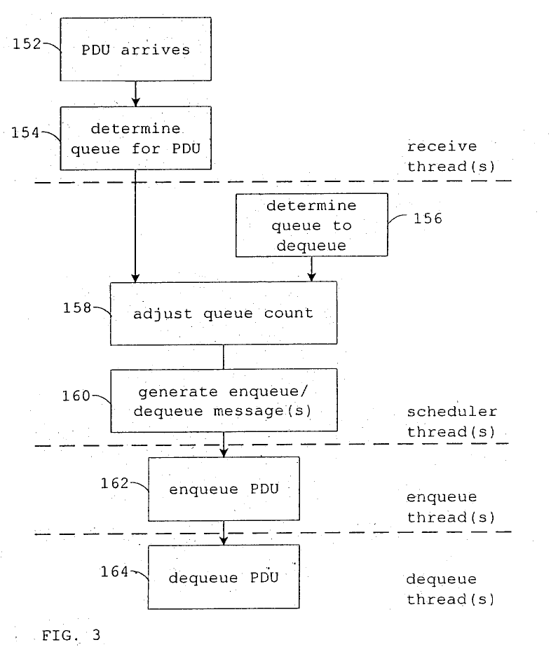

FIG. 3 is a flow-chart of an implementation of the operations described above. As shown, receive thread(s) classify 154 received 152 PDUs. The scheduling thread(s) adjust 158 queue status data based on the queues assigned 154 to the PDUs and the queues scheduled 156 for dequeuing. The scheduling threads notify 160 the enqueue and dequeue threads of the queues slated for enqueuing 162 and dequeuing 164.

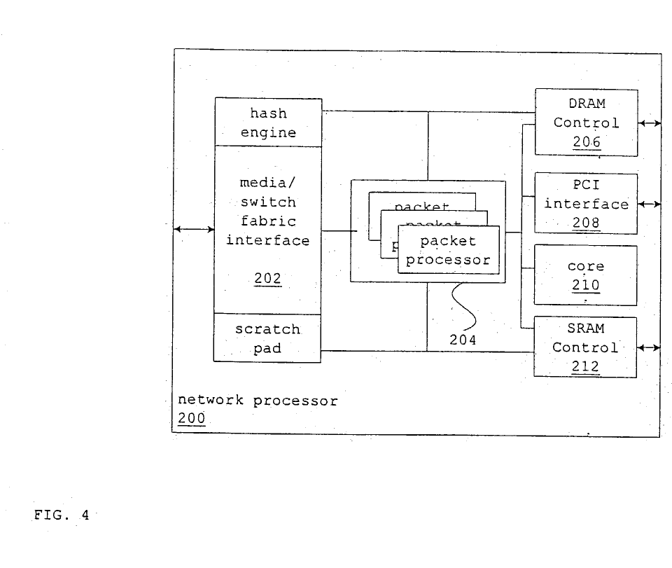

The techniques described above may be used in a variety of environments. For example, the threads described above may be executed by a programmable network processor. FIG. 4 depicts an example of network processor 200. The network processor 200 shown is an Intel® Internet exchange network Processor (IXP). Other network processors feature different designs.

As shown, the network processor 200 features interfaces 202 that can carry PDUs between the processor 200 and other network components. For example, the processor 200 can feature a switch fabric interface (e.g., a CSIX interface) that enables the processor 200 to transmit a PDU to other processor(s) or circuitry connected to the fabric. The processor 200 can also feature an interface (e.g., a System Packet Interface Level 4 (SPI-4) interface) that enables to the processor 200 to communicate with physical layer (PHY) and/or link layer devices. The processor 200 also includes an interface 208 (e.g., a Peripheral Component Interconnect (PCI) bus interface) for communicating, for example, with a host. As shown, the processor 200 also includes other components such as memory controllers 206, 212, a hash engine, and scratch pad memory. The accessible memory may be used to store the queues and buffer PDUs.

The network processor 200 shown features a collection of packet processors 204. The packet processors 204 may be Reduced Instruction Set Computing (RISC) processors tailored for network PDU processing. For example, the packet processors may not include floating point instructions or instructions for integer multiplication or division commonly provided by general purpose central processing units (CPUs).

An individual packet processor 204 may offer multiple threads. The multi-threading capability of the packet processors 204 is supported by hardware that reserves different registers for different threads and can quickly swap thread contexts. Packet processors 204 may communicate with neighboring processors 204, for example, using neighbor registers or other shared memory.

The processor 200 also includes a core processor 210 (e.g., a StrongARM® XScale®) that is often programmed to perform “control plane” tasks involved in network operations. The core processor 210, however, may also handle “data plane” tasks and may provide additional packet processing threads.

The threads of packet processors 204 and core 210 may be allocated to the processes shown in FIG. 1 in a variety of ways. For example, threads of a given packet processor 204 may all be allocated to a different processes within a pipeline. Alternately, the threads of a particular processor 204 may be allocated to the same process. For example, multiple threads of a given processor 204 may execute receive process 102 operations.

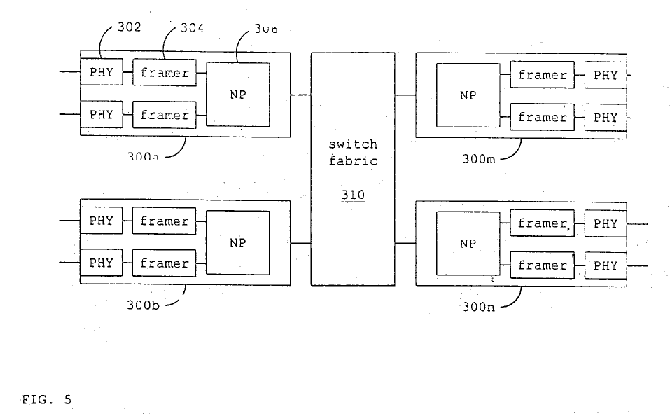

FIG. 5 depicts a network device incorporating techniques described above. As shown, the device features a collection of line cards 300 (“blades”) interconnected by a switch fabric 310 (e.g., a crossbar or shared memory switch fabric). The switch fabric, for example, may conform to CSIX. Other fabric technologies include HyperTransport, Infiniband, PCI-X, Packet-Over-SONET, RapidIO, and Utopia.

Individual line cards (e.g., 300a) include one or more physical layer (PHY) devices 302 (e.g., optic, wire, and wireless PHYs) that handle communication over network connections. The PHYs translate between the physical signals carried by different network mediums and the bits (e.g., “0”-s and “1”-s) used by digital systems. The line cards 300 may also include framer 304 devices (e.g., Ethernet, Synchronous Optic Network (SONET), or High-Level Data Link (HDLC) framers) that can perform operations on frames such as error detection and/or correction. The line cards 300 shown also include one or more network processors 306 that execute instructions to process PDUs (e.g., framing, selecting an egress interface, and so forth) received via the PHY(s) 302 and direct the PDU's, via the switch fabric 310, to a line card providing the selected egress interface.

While FIGS. 4 and 5 described a network processor, the techniques may be implemented in other hardware, firmware, and or software. For example, the techniques may be implemented in integrated circuits (e.g., Application Specific Integrated Circuits (ASICs), Gate Arrays, and so forth).

Preferably, the processes and/or threads are implemented in computer programs such as a high level procedural or object oriented programming language. However, the program(s) can be implemented in assembly or machine language if desired. The language may be compiled or interpreted. Additionally, these techniques may be used in a wide variety of networking environments.

Other embodiments are within the scope of the following claims.

What is claimed is:

1. A method of enqueuing and dequeuing queue entries for protocol data units, the method comprising:
assigning a queue from a set of queues to a received protocol data unit;
determining a queue from the set of queues to dequeue based on a scheduling policy;
adjusting a count of entries of the queue to dequeue and the queue assigned to the protocol data unit; and
after the adjusting:
enqueuing an entry for the received protocol data unit in the assigned queue; and
dequeueing an entry in the queue to dequeue.

2. The method of claim 1, wherein the assigning, determining, adjusting, enqueuing, and dequeuing comprise operations performed by at least two different threads.

3. The method of claim 2, wherein the different threads comprise threads executed by a network processor having multiple packet processors.

4. The method of claim 2, wherein the different threads comprise threads of a packet processing pipeline.

5. The method of claim 1,
wherein the protocol data unit comprises an Internet Protocol (IP) datagram that encapsulates at least a portion of a Transmission Control Protocol (TCP) segment; and
wherein assigning a queue to the received protocol data unit comprises assigning a queue based on at least one of the following: the datagram's IP source address, the datagram's IP destination address, the datagram's TCP source port, the datagram's TCP destination port, a Universal Resource Indicator (URI) embedded a HyperText Transfer Protocol (HTTP) message included in the TCP segment, a transport layer protocol, a class of service, a network path label, and a security parameter.

6. The method of claim 1, further comprising transmitting data of a protocol data unit associated with the dequeued entry over a switch fabric.

7. A pipeline to enqueue and dequeue protocol data units from a set of queues, the pipeline comprising:
a first set of at least one thread to:
assign protocol data units to queues;
determine queues to dequeue based on a scheduling policy; and
adjust a count of the queues to reflect the assigned queues and the queues to dequeue; and
a second set of at least one thread to:
enqueue entries for protocol data units in the assigned queues; and
dequeue entries from the determined queues to dequeue.

8. The system of claim 7, wherein the first set of threads comprise threads of:
a receive process to assign protocol data units to queues; and
a scheduling process to:
determine queues to dequeue based on a scheduling policy; and
adjust a count of the queues to reflect the assigned queues and the queues to dequeue.

9. The system of claim 7, wherein the second set of threads comprise threads of:
an enqueue process to enqueue entries for protocol data units in the assigned queues; and
a dequeue process to dequeue entries from the determined queues to dequeue.

10. The system of claim 7, wherein the first set of threads transmit at least one message to at least one thread in the second set of threads, the at least one message identifying a queue assigned to a protocol data unit and the queue(s) to dequeue.

11. The system of claim 7, wherein the first and second set of threads comprise threads executed by a network processor having multiple packet processors.

12. The system of claim 7, wherein the second set of threads comprise at least one thread to segment data of a protocol data unit for transmission via a switch fabric.

13. A system to enqueue and dequeue entries for protocol data units, the system comprising:
an enqueue path, comprising path operations to:
assign a protocol data unit to a queue from a set of queues;
determine at least one queue to dequeue based on a scheduling policy;
adjust a count of entries in the queues to reflect the assigned queues and the determined queues to dequeue;
enqueue entries for protocol data units in the assigned queues; and
a dequeue process to dequeue entries from the determined queues to dequeue.

14. The system of claim 13, wherein the enqueue path and the dequeue process comprise a set of threads.

15. The system of claim 13, wherein the enqueue path comprises:
a receive process to assign the protocol data unit to the queue; and
a scheduling process to:
determine the at least one queue to dequeue; and
adjust the count of entries in the queues.

16. The system of claim 15, wherein the enqueue path transmits a message to the dequeue process that identifies the at least one queue to dequeue.

17. The system of claim 13, wherein the dequeue process segments data of a protocol data unit for transmission via a switch fabric.

18. The method of claim 13,
wherein the protocol data unit comprises an Internet Protocol (IP) datagram that encapsulates at least a portion of a Transmission Control Protocol (TCP) segment; and
wherein operations to assign the queue to the received protocol data unit comprises operations to assign the based on at least one of the following: the datagram's IP source address, the datagram's IP destination address, the datagram's TCP source port, the datagram's TCP destination port, a Universal Resource Indicator (URI) embedded a HyperText Transfer Protocol (HTTP) message included in the TCP segment, a transport layer protocol, a class of service, a network path label, and a security parameter.

19. A system, comprising:
a set of line cards, an individual line card including:
at least one physical layer (PHY) device;
a network processor having more than one processor, the network processor having access to instructions that cause the network processor processor(s) to execute:
a first set of at least one thread to:
assign protocol data units to queues;
determine queues to dequeue based on a scheduling policy; and
adjust a count of the queues to reflect the assigned queues and the queues to dequeue; and
a second set of at least one thread to:
enqueue entries for protocol data units in the assigned queues; and
dequeue entries from the determined queues to dequeue; and
a crossbar switch fabric interconnecting the set of line cards.

20. The system of claim 19, wherein the at least one physical layer device comprises an wire PHY.

21. The system of claim 19, wherein the individual line card comprises an Ethernet framer.

22. The system of claim 19, wherein the protocol data unit comprises an Internet Protocol (IP) datagram.

23. A computer program product, disposed on a computer readable medium, the program product to enqueue and dequeue entries for protocol data units, the program including instructions for causing at least one processor to:
assign a queue from a set of queues to a received protocol data unit;
determine a queue from the set of queues to dequeue based on a scheduling policy;
adjust a count of entries of the queue to dequeue and the queue assigned to the protocol data unit; and
after the adjusting:
enqueue an entry for the protocol data unit in the assigned queue; and
dequeue an entry in the queue to dequeue.

24. The product of claim 23, wherein the instructions that cause the processor(s) to assign, determine, adjust, enqueue, and dequeue comprise instructions of at least two different threads.

25. The product of claim 23,
wherein the protocol data unit comprises an Internet Protocol (IP) datagram that encapsulates at least a portion of a Transmission Control Protocol (TCP) segment; and
wherein assigning a queue to the received protocol data unit comprises assigning a queue based on at least one of the following: the datagram's IP source address, the datagram's IP destination address, the datagram's TCP source port, the datagram's TCP destination port, a Universal Resource Indicator (URI) embedded a HyperText Transfer Protocol (HTTP) message included in the TCP segment, a transport layer protocol, a class of service, a network path label, and a security parameter.

26. The product of claim 23, further comprising instructions for causing the processor(s) to transmit data of a protocol data unit associated with the dequeued entry over a switch fabric.
